(19) United States
(12) Patent Application Publication
(10) Pub. No.: US 2007/0150761 A1
(43) Pub. Date: Jun. 28, 2007

(54) Power supply communication system and method

(75) Inventors: Charles A. Beyer, Pittsborro, NC (US); Candice L. Coletrane, Durham, NC (US); Henry C. Saunders, Willow Springs, NC (US); Robert H. Sharrar, Garner, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/320,030

(22) Filed: Dec. 28, 2005

(51) Int. Cl. G06F 1/00

(52) U.S. Cl. 713/300

(57) ABSTRACT

A power supply system for providing power to a device includes a power supply separate from the device, a power supply communication module attached to the power supply, and a device communication module attached to the device. The device communication module communicates voltage and/or current requirements of the device to the power supply via the power supply communication module. A power line is included between the power supply and the device. A communication line may be included between the device communication module and the power supply communication module and/or the device communication module communicates wirelessly with the power supply communication module. The communication line may be separate from the power line or part of the power line. The power line has one end that is attachable to the device.

### BACKGROUND OF THE INVENTION

1. Field of the Invention

The disclosure relates generally to electrical systems and, more specifically, to a system and method for communicating voltage and/or current requirements from a device to a power supply.

2. Description of the Related Art

Many electrical devices use DC power to operate, and many of these devices are connected to a separate AC/DC power supply adapter to supply the DC power to the device. A conventional AC/DC power supply adaptor includes a plug that is inserted into an AC power supply, such as a wall outlet. Also, the conventional power supply adaptor includes an AC/DC power converter that converts the AC power into DC power and a DC power outlet that is connected to the device.

The conventional power supply adaptor is typically limited as to the voltage supplied (e.g., 12 volts). Additionally, the conventional power supply adaptor is typically limited as to the maximum current supplied (e.g., 200 mAmps). As a result, since the voltage/current power requirements of devices vary considerably, many different configurations of power supply adaptors are needed to supply the many possible different voltage/current power requirements. Therefore, for many users of multiple devices, a single power supply adaptor is not capable of supplying the voltage/current power requirements for all of the devices having different voltage/current power requirements. There is, therefore, a need for a system and method for providing different voltage/current power requirements to a device from a single power supply adaptor.

### BRIEF SUMMARY OF THE INVENTION

Embodiments of the invention address deficiencies of the art in respect to power supplies to provide a novel and non-obvious system and method for communicating different voltage and/or current requirements of a device to a power supply. The power supply system includes a power supply separate from the device, a power supply communication module attached to the power supply, and a device communication module attached to the device. The device communication module communicates voltage and/or current requirements of the device to the power supply via the power supply communication module. A power line is included between the power supply and the device. A communication line may be included between the device communication module and the power supply communication module and/or the device communication module communicates wirelessly with the power supply communication module. The communication line may be separate from the power line or part of the power line. The power line has one end that is attachable to the device.

In yet another aspect, a method for communicating different voltage and/or current requirements of a device to a power supply includes the steps of requesting, by a power supply communication module attached to the power supply, power requirements from a device communication module attached to the device; receiving, by the power supply communication module, specified voltage and/or current requirements of the device from the device communication module; and supplying power having the specified voltage and/or current requirements to the device.

The requesting step includes attaching a power line to the device. The step of supplying power to the device communication module occurs prior to the receiving step. The requesting step and/or receiving step are performed wirelessly and/or using a communication line connecting the power supply communication module to the device communication module. The process may also include the steps of receiving, by the power supply communication module, a different specified voltage and/or current requirements of the device from the device communication module; and supplying power having the different specified voltage and/or current requirements to the device.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1A is a block diagram of a power supply, device, and wired communication system in accordance with the inventive arrangements;

FIG. 1B is a block diagram of a power supply, device, and wireless communication system in accordance with the inventive arrangements; and

FIG. 2 is a flow chart diagram illustrating a method of supplying voltage and/or current requirements of a device to a power supply in accordance with the inventive arrangements.

### DETAILED DESCRIPTION OF THE INVENTION

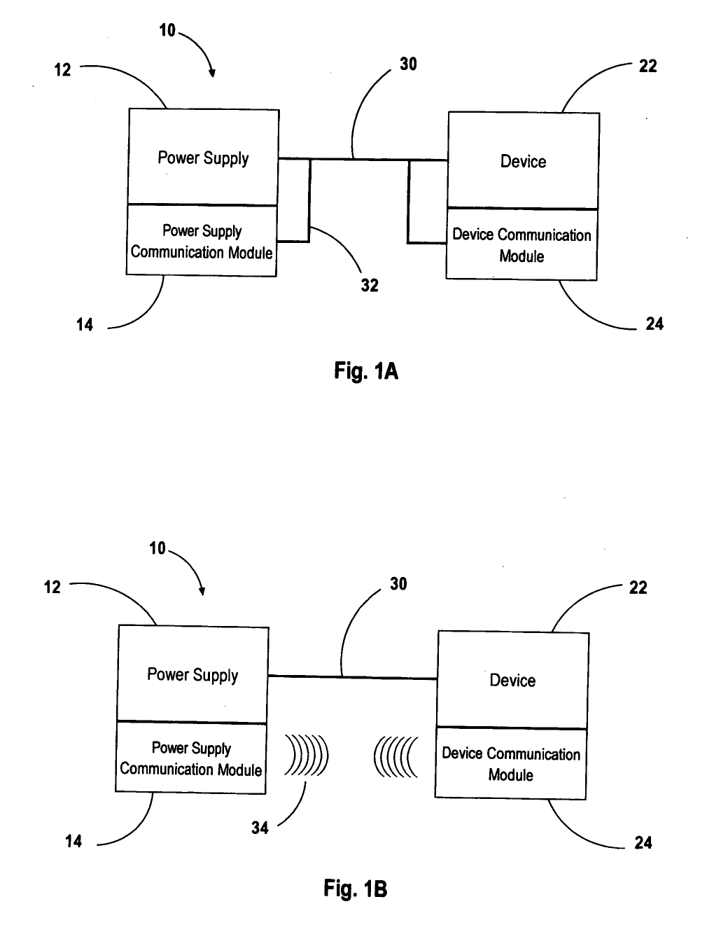

FIGS. 1A and 1B illustrate a power supply system 10 for communicating voltage and/or current supply requirements for a device 22 to a power supply 12. The power supply system 10 includes a power supply communication module 14 that is connected to the power supply 12 and a device communication module 24 that is connected to the device 22. The power supply communication module 14 may be connected to the device communication module 24 either via a communication line 32 (i.e., FIG. 1A) or via a wireless connection 34 (i.e., FIG. 1B). The power supply system 10 is capable of being used with any electrical device 22 that has particular voltage and/or current requirements.

Many of the functional units described in this specification have been labeled as modules, in order to more particularly emphasize their implementation independence. For example, a module may be implemented as a hardware circuit comprising custom circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

A module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The power supply 12 is capable of adjusting the voltage and/or current being supplied to the device 22. Many different types of power supplies capable of producing variable voltage and/or current are known, and the present power supply 12 is not limited as to a particular power supply so capable. In certain aspects of the power supply system 10, the power supply 12 receives AC power from an AC power supply (not shown) and converts the AC power supply into DC power, which is then supplied to the device 22. However, the power supply 12 is not limited in this manner. For example, the power supply 12 can receive either DC power or AC power from a power source and convert this source power into either DC and/or AC power having the specified voltage and/or current requirements of the device 22.

In certain aspects of the power supply system 10, the power supply 12 is current limiting. As such, the power supply 12 does not provide any additional current to the device 22 beyond the current requirements specified by the device communication module 24. In certain instances, in which a device 22 is not operating properly (e.g., a short exists within the device 22), the device 22 will draw as much current from the power supply 12 as possible. Unlike conventional power supplies, in which the device can draw up to the limit provided by the power supply, even if the device only requires an amount of current substantially less than the limit of the power supply, the present power supply 12 only provides the amount of current specified by the device communication module 24.

In certain aspects of the power supply system 10, the power supply 12 supplies power to the device 22 via a power line 30. A multitude of different types and configurations of lines 30 are capable of supplying power from a power supply 12 to a device 22, and the power supply system 10 is not limited as to a particular power line 30 so capable. However, the power supply 12 is not limited to supplying power to the device 22 via a power line 30. For example, the power supply 12 may be a RF power supply that supplies power to the device 22 via RF. In this configuration, a power line 30 is not required to supply power from the power supply 12 to the device 22.

The power supply system 10 includes a power supply communication module 14 that communicates with a device communication module 24 either via a communication line 32 or wirelessly 34. As illustrated in FIG. 1A, the power supply communication module 14 communicates with the device communication module 24 via a communication line 32. The communication line 32 may be a separate from the power line 30 that supplies the power to the device 22.

In another configuration, the communication line 32 that is used for communication between the power supply communication module 14 and the device communication module 24 may be integrated with the power line 30 that supplies the power to the device 22. If integrated, the lines 30, 32 can be within a single cable that is connects the power supply 12 to the device 22. Alternatively, communication between the power supply communication module 14 and the device communication module 24 may be performed over the power line 30

The power line 30 and/or the communication line 32 may be removably attachable to the device 22, and power system 10 is not limited in the manner in which this is accomplished. For example, many types of connectors that are capable of being used with a line to allow the line to be inserted into (or removed from) a device 32 are known. In certain aspects of the power system 10, the power line 30 and the communication line 32 include a connector at one end that is attachable to the device 22.

As illustrated in FIG. 1B, the power supply communication module 14 communicates with the device communication module 24 via a wireless connection 34. Many types of wireless systems are capable of communicating via a wireless connection 34, and the power supply communication module 14 and the device communication module 24 are not limited as to a particular wireless system so capable.

The power supply system 10 is not limited in the manner in which the power line 30 and/or communication line 32 are connected to the power supply 12 or device 22. The lines 30, 32 may be directly connected to the power supply 12 or device 22 or the line(s) 30, 32 may be indirectly connected to the power supply 12 and device 22 respectively via the power supply communication module 14 and device communication module 24. For example, either one or both of the power supply communication module 14 and the device communication module 24 may be integral with a connector of line(s) 30, 32 that respectively connect to the power supply 12 or device 22.

The power supply communication module 14 may be integral with the power supply 12. Alternatively, the power supply communication module 14 may be attachable to the power supply 12. Upon receiving voltage and/or current requirements from the device communication module 24, the power supply communication module 14 directs the power supply 12 to provide power to the device 22 with the specified voltage and/or current. These requirements may be communicated to the power supply 12 via a switch located within the power supply communication module 14 that controls the voltage and/or current of the power being supplied by the power supply 12. Alternatively, the switch may be located within the power supply 12, and the power supply communication module 14 communicates the voltage and/or current requirements to the switch.

The device communication module 14 may be integral with the device 22. Alternatively, the device communication module 14 may be attachable to the device 22. If the device communication module 14 is attachable to the device 22, upon being attached to the device 22, the device communication module 14 determines the voltage and/or current requirements of the device 22. The device communication module 14, however, is not limited in the manner in which the voltage and/or current requirements of the device 22 are obtained. For example, the requirements may be obtained by polling a register within the device 22 that provides the voltage and/or current requirements or detecting the type of the device 22 and deducing the voltage and/or current requirements by the type of the device 22. If the device communication module 14 is integral with the device 22, the device communication module 14 may access the voltage and/or current requirements of the device 22 that are stored within the device communication module 24, the device 22, or elsewhere.

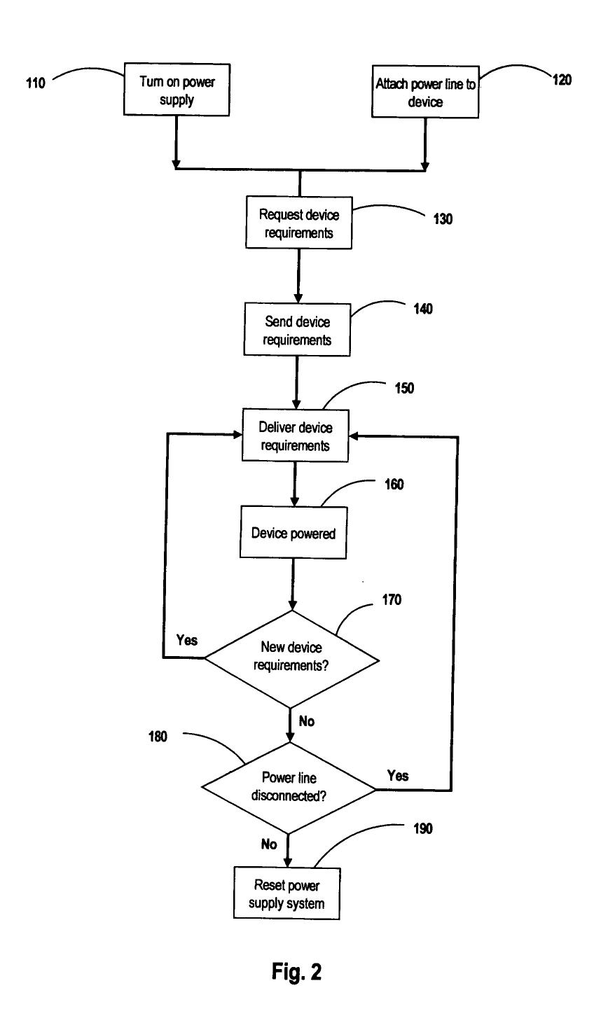

FIG. 2 illustrates an example of the manner in which the power supply system 100 may operate. After the power line 30 has been attached to the device in step 120 and the power supply 12 has been turned on in step 110, the power supply communication module 14 sends a request to the device communication module 24 for the voltage and/or current requirements of the device 22 in step 130. In step 140, the device communication module 24 communicates with the power supply communication module 14 to supply the power supply communication module 14 with the voltage and/or current requirements of the device 22.

While the device communication module 24 is being polled by the power supply communication module 14, the power supply 12 may be directed to provide only enough voltage/current to supply the operation of the device communication module 24 and not the device 22. In this manner, the device 22 may be prevented from being under-/over-supplied with power prior to the power supply 12 being controlled to provide the requested voltage and/or current requirements.

In step 150, the voltage and/or current requirements of the device 22 are communicated from the device communication module 24 to the power supply communication module 14. After the power supply communication module 14 directs the power supply 12 to provide power to the device 22 with the specified requirements for voltage and/or current, in step 160, the device 22 receives the specified power from the power supply 12.

After performing their specified functions, one or both of the device communication module 24 and the power supply module 14 may be completely or partially shut down. However, in certain aspects, the device communication module 24 is capable of obtaining different voltage and/or current requirements from the device 22, and in step 170, the device communication module 24 communicates the new requirements to the power supply communication module 14, after which, steps 150 and 160 are repeated. Upon the power line 30 being disconnected from the device 22, the power supply system 10 may be reset to restart the process.

What is claimed is:

1. A power supply system for providing power to a device, comprising:
a power supply separate from the device;
a power supply communication module attached to the power supply; and
a device communication module attached to the device, wherein
the device communication module communicates voltage and/or current requirements of the device to the power supply via the power supply communication module.

2. The power supply system of claim 1, further comprising a power line between the power supply and the device.

3. The power supply system of claim 2, further comprising a communication line between the device communication module and the power supply communication module.

4. The power supply system of claim 3, wherein the communication line separate from the power line.

5. The power supply system of claim 1, wherein the device communication module communicates wirelessly with the power supply communication module.

6. A power supply for providing power to a device separate from the power supply, comprising:
a power supply communication module for receiving specified voltage and/or current requirements of the device via a device communication module attached to the device, wherein
the power supply communication module directing the power supply to provide power having the specified voltage and/or current requirements to the device.

7. The power supply of claim 6, further comprising a power line having one end attachable to the device.

8. The power supply of claim 7, further comprising a communication line between the device communication module and the power supply module.

9. The power supply of claim 8, wherein the communication line separate from the power line.

10. The power supply of claim 6, wherein the power supply communication module communicates wirelessly with the device communication module.

11. An electronic device receiving power from a power supply separate from the device, comprising:
a device communication module for communicating specified voltage and/or current requirements of the device to a power supply communication module attached to the power supply.

12. The electronic device of claim 11, wherein the device communication module communicates with the power supply communication module via a communication line.

13. The electronic device of claim 11, wherein the device communication module communicates wirelessly with the power supply communication module.

14. A method of communicating voltage and/or current requirements of a device to a power supply, comprising the steps of:
requesting, by a power supply communication module attached to the power supply, power requirements from a device communication module attached to the device;
receiving, by the power supply communication module, specified voltage and/or current requirements of the device from the device communication module; and
supplying power having the specified voltage and/or current requirements to the device.

15. The method according to claim 14, wherein the requesting step includes attaching a power line to the device.

16. The method according to claim 14, further comprising the step of supplying power to the device communication module prior to the receiving step.

17. The method according to claim 14, wherein at least one of the requesting step and the receiving step are performed wirelessly.

18. The method according to claim 14, wherein at least one of the requesting step and the receiving step are performed using a communication line connecting the power supply communication module to the device communication module.

19. The method according to claim 14, further comprising the steps of:
receiving, by the power supply communication module, a different specified voltage and/or current requirements of the device from the device communication module; and
supplying power having the different specified voltage and/or current requirements to the device.
